(19) United States
(12) Patent Application Publication
(10) Pub. No.: US 2009/0187466 A1
(43) Pub. Date: Jul. 23, 2009

(54) Location-Based Information-Geo Retail Notification

(75) Inventors: Paul Patrick Carter, Paeonian Springs, VA (US); Matthew Paul Link, Kapolei, HI (US)

Correspondence Address: BANNER & WITCOFF, LTD., 1100 13th STREET, N.W., SUITE 1200, WASHINGTON, DC, 20005-4051, US

(73) Assignee: MapHook, Inc., Paeonian Springs, VA (US)

(21) Appl. No.: 12/018,474

(22) Filed: Jan. 23, 2008

(51) Int. Cl. G06Q 10/00

(52) U.S. Cl. 705/10

(57) ABSTRACT

Sales information corresponding to one or more retailers is collected and stored. A customer/user can access the sales information using a client application running on his mobile device. The access may be responsive to a customer profile that establishes the customer's preferences or tastes. The access may be responsive to detecting that the customer's mobile device is within a threshold distance of one or more matching retailers. The access may be responsive to a customer request to obtain the sales information. One or more reminder notes may be sent to the customer to serve as a reminder that the customer likely needs to acquire a product or service.

### FIELD

Aspects of the invention generally relate to wireless computing technologies. More specifically, an apparatus, method and system are described for providing the ability to acquire information related to a good or service of interest responsive to a mobile terminal being located within a threshold distance of the good or service.

### BACKGROUND

Improvements in computing technologies have changed the way people interact with their surrounding environment. For example, businesses have adapted their traditional sales/marketing models in order to facilitate advertising on the Internet. Most modern businesses and corporations have embraced technological advancements to take advantage of potential sales and marketing opportunities. Some conservative estimates indicate that Internet advertising may be responsible for up to ten percent of all sales by the average business or corporation. Irrespective of the actual share, it suffices to say that taking advantage of such opportunities will influence how successful a business is in a competitive marketplace.

In order for an advertisement to be effective, not only does the advertisement have to reach its target audience, the advertisement also has to reach a member of the target audience at an appropriate time and location. For example, a retailer/designer of trendy snow boots may want to advertise the boots to teenagers (aged 13-18) located in Connecticut during the winter months (e.g., December, January and February) to maximize the return on her investment. The advertisement might not be as effective if it reaches Ross, a fifteen year old resident of Hartford, Conn., while he is in Florida working on his suntan in June.

Continuing the hypothetical example above, when Ross returns to Hartford in early December, he may be interested in purchasing a new pair of snow boots. Ross is an economizing individual, however, and wants to shop for the best bargain he can find based on a variety of factors (e.g., price, color, style, quality, manufacturer reputation and the like).

Thus, what is needed in the art is an ability to direct an advertisement to a member of a target audience based on the member's location at a given point in time. Furthermore, what is needed in the art is an ability to compare sales information and advertisements in accordance with one or more criteria so that a consumer can obtain a product or service that most directly satisfies his desires or needs.

### BRIEF SUMMARY

The following presents a simplified summary of aspects of the invention in order to provide a basic understanding of some aspects of the invention. This summary is not an extensive overview, and is not intended to identify key or critical elements or to delineate the scope of the claims. The following summary merely presents some concepts and aspects of the invention in a simplified form as a prelude to the more detailed description provided below.

To overcome limitations in the prior art described above, and to overcome other limitations that will be apparent upon reading and understanding the present specification, aspects of the present invention are directed to a novel apparatus, method and system for generating and transmitting one or more advertisements to a computer platform. Aspects may provide for receiving information to populate a customer/user profile, entering data in the form of sales information, receiving data identifying a location of a computing platform, comparing the customer/user profile and the sales information, and transmitting one or more advertisements to the computing platform.

A first aspect provides an interface to receive information to populate a profile.

A second aspect provides an interface to receive data related to a sales item.

A third aspect provides for determining a location of a computing platform.

A fourth aspect provides for determining a location of at least one good or service.

A fifth aspect provides for a computation of the distance between the location of the computing platform and a location of the at least one good or service.

A sixth aspect provides for a comparison between the computed distance and a threshold to determine whether the computing platform is in sufficiently close proximity to the at least one good or service.

A seventh aspect provides for receiving at the computing platform one or more advertisements when the computing platform is within a threshold distance of the at least one good or service.

These and other aspects of the invention generally relate to the entry of information or data relating to a customer profile to establish customer preferences with respect to at least one good or service. One or more retailers may enter sales information into a database, the information relating to the at least one good or service. A distance between a customer's mobile terminal and the location of the at least one good or service may be calculated and then subsequently compared to determine if the distance is less than a threshold value. When the calculated distance is less than the threshold value, the sales information may be forwarded to the customer's mobile terminal. The sales information may be an aggregate of information derived from more than one retailer, or the information may be derived from a single retailer based on a “best-fit” comparison between the sales information provided by a selected retailer and the customer profile.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a network computing environment suitable for carrying out one or more illustrative aspects of the invention.

FIG. 2 illustrates a mobile device suitable for carrying out one or more illustrative aspects of the invention.

FIG. 3 illustrates a data processing architecture suitable for carrying out one or more illustrative aspects of the invention.

FIG. 4A illustrates a flow diagram suitable for carrying out one or more aspects of the invention described herein.

FIG. 4B illustrates a series of reminder notes suitable for carrying out one or more aspects of the invention described herein.

FIGS. 5A-C illustrate exemplary screen shots suitable for creating and managing a profile in accordance with one or more aspects of the invention described herein.

FIG. 6 illustrates a flow chart suitable for carrying out one or more aspects of the invention described herein.

FIG. 7 illustrates an example screen shot suitable for conveying sales information in accordance with one or more aspects of the invention described herein.

### DETAILED DESCRIPTION

In the following description of the various embodiments, reference is made to the accompanying drawings, which form a part hereof, and in which is shown by way of illustration various embodiments in which one or more aspects of the invention may be practiced. It is to be understood that other embodiments may be utilized and structural and functional modifications may be made without departing from the scope of the present invention.

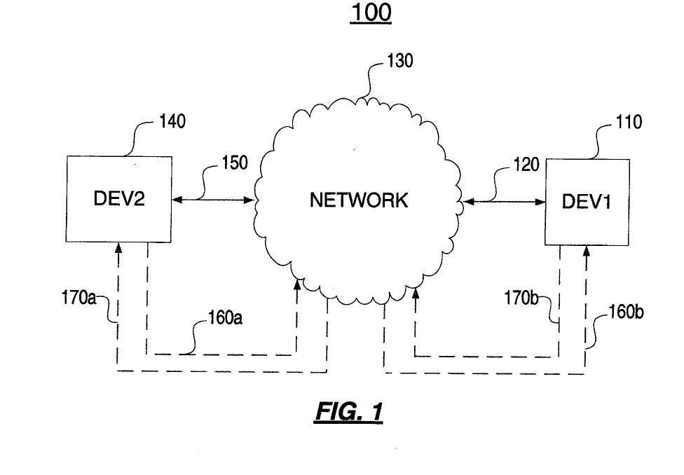

FIG. 1 illustrates a network computing environment 100 suitable for carrying out one or more aspects of the present invention. For example, FIG. 1 illustrates a first device DEV1 110 connected to a network 130 via a connection 120. Network 130 may include the Internet, an intranet, wired or wireless networks, or any other mechanism suitable for facilitating communication between computing platforms in general. FIG. 1 also depicts a second device DEV2 140 connected to network 130 via a connection 150. By virtue of the connectivity as shown, DEV1 110 and DEV2 140 may communicate with one another. Such communications may enable the exchange of various types of information. For example, the communications may include data to be exchanged between DEV1 110 and DEV2 140. Such data may include files, sales information, advertisements and the like. The communications may further include additional information such as control information.

Connections 120 and 150 illustrate interconnections for communication purposes. The actual connections represented by connections 120 and 150 may be embodied in various forms. For example, connections 120 and 150 may be hardwired/wireline connections. Alternatively, connections 120 and 150 may be wireless connections. Connections 120 and 150 are shown in FIG. 1 as supporting bidirectional communications (via the dual arrow heads on each of connections 120 and 150). Alternatively, or additionally, computing environment 100 may be structured to support separate forward (160a and 160b) and reverse (170a and 170b) channel connections to facilitate the communication.

Computing environment 100 may be carried out as part of a larger network consisting of more than two devices. For example, DEV2 140 may exchange communications with a plurality of other devices (not shown) in addition to DEV1 110. The communications may be conducted using one or more communication protocols. Furthermore, computing environment 100 may include one or more intermediary nodes (not shown) that may buffer, store, or route communications between the various devices.

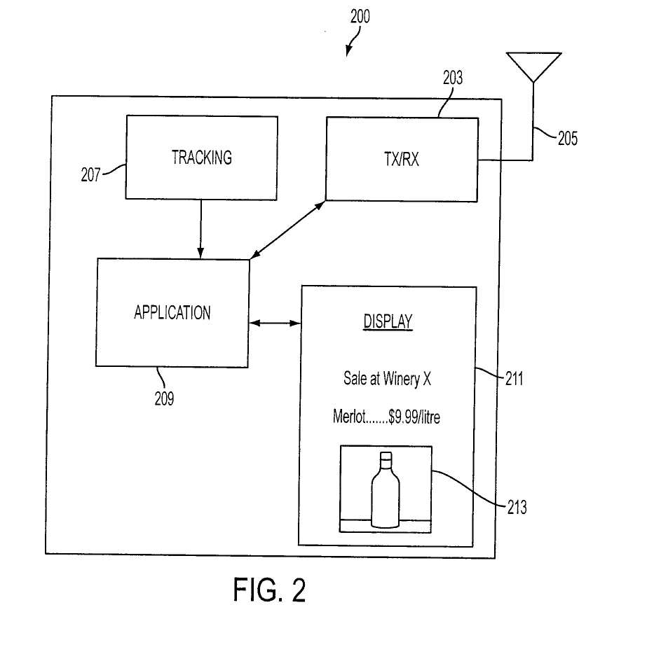

FIG. 2 illustrates a mobile device suitable for carrying out one or more illustrative aspects of the invention. More specifically, mobile device 200 may include a transmit/receive (Tx/Rx) module 203. Tx/Rx module 203 may work in conjunction with antenna 205 to transmit and receive signals with other mobile devices, base stations, and computing entities in general. Mobile device 200 may also include tracking module 207. Tracking module 207 may be based on any location tracking protocols or devices, and may include Global Positioning System (GPS) equipment, for example. Mobile device 200 may also include an application module 209. Application module 209 may be incorporated on mobile device 200 when mobile device 200 is fabricated. Alternatively, application module 209 and/or updates to application module 209 may be downloaded (e.g., via Tx/Rx module 203) to mobile device 200 after mobile device 200 is already in the field. Tx/Rx module 203 and tracking module 207 may provide inputs to application module 209. Application module 209 may operate on the one or more inputs it receives, and send the results of the operation(s) to Tx/Rx module 203 to be transmitted to other mobile devices, base stations, and/or other computing entities. Application module 209 may also communicate with display 211 to provide content suitable for display on mobile device 200. For example, in the context of an advertisement associated with a Winery X, display 211 may show a price listing of a bottle of merlot (e.g., Merlot . . . $9.99/litre) offered for sale at Winery X. One or more images may also be generated (in FIG. 2, a bottle 213 is shown). All of the referenced modules may be incorporated as software, hardware, firmware, or some combination thereof.

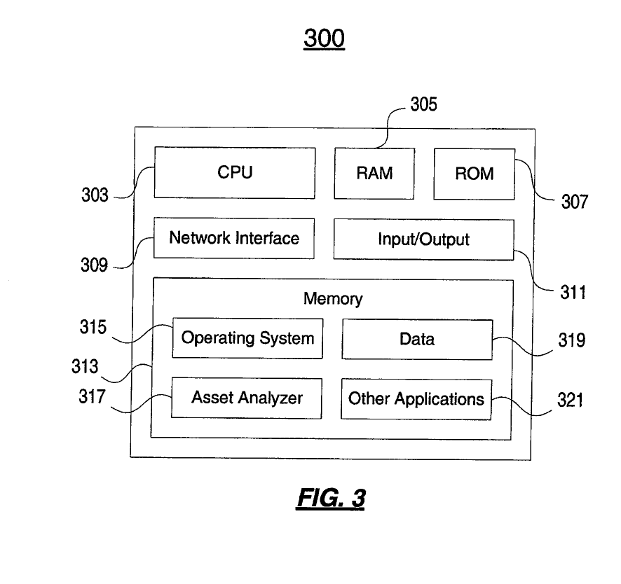

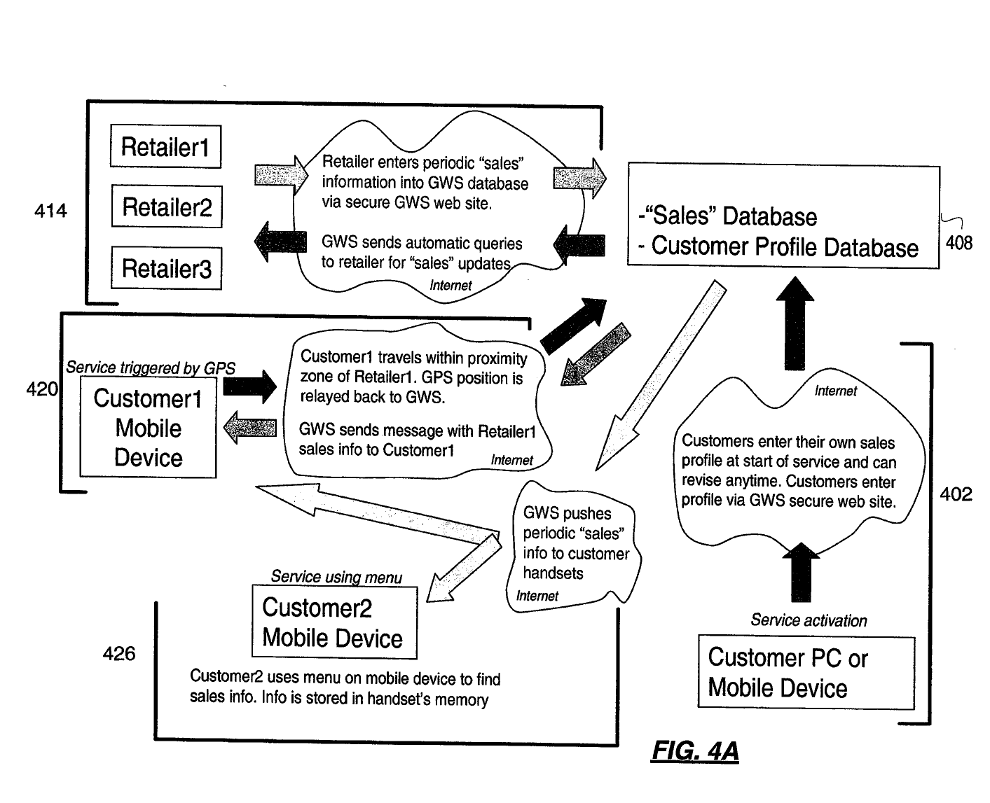

FIG. 3 illustrates a computer 300 that represents a generic computing device, e.g., a desktop computer, laptop computer, notebook computer, network server, portable computing device, personal digital assistant, smart phone, mobile telephone, terminal, distributed computing network device, or any other device having the requisite components or abilities to operate as described herein. Computer 300 may include central processing unit or other processor 303, RAM or other volatile memory 305, ROM or other boot memory 307, network interface(s) 309 (e.g., Ethernet, wireless network interface, modem, etc.) through which computer 300 connects to a network (e.g., Internet, LAN, WAN, PAN, etc.), input/output port(s) 311 (e.g., keyboard, mouse, monitor, printer, USB ports, serial ports, parallel ports, IEEE 1394/Firewire ports, and the like), and non-volatile memory 313 (e.g., fixed disk, optical disk, holographic storage, removable storage media, flash drive, etc.). Computer 300 may store various programs, application, and data in memory 313, including, but not limited to, operating system software 315, hardware/software/firmware asset analyzer 317, data 319 (e.g., historical data including past search results, and other data described herein), and other application(s) 321. Other applications 321 may include one or more applications to support location tracking, such as tracking via GPS.

Computer program product implementations may include a series of computer instructions fixed either on a tangible medium, such as a computer readable medium (e.g., a diskette, CD-ROM, ROM, DVD, fixed disk, etc.) or transmittable to computer system 300, via a modem or other interface device 309, such as a communications adapter connected to a network over a medium, which is either tangible (e.g., optical or analog communication lines) or implemented wirelessly (e.g., microwave, infrared, or other transmission techniques). The series of computer instructions may embody all or part of the functionality with respect to the computer system, and can be written in a number of programming languages for use with many different computer architectures and/or operating systems, as would be readily appreciated by one of ordinary skill. The computer instructions may be stored in any memory device, such as a semiconductor, magnetic, optical, or other memory device, and may be transmitted using any communications technology, such as optical infrared, microwave, or other transmission technology. Such a computer program product may be distributed as a removable medium with accompanying printed or electronic documentation (e.g., shrink wrapped software), preloaded with a computer system (e.g., on system ROM or fixed disk), or distributed from a server or electronic bulletin board over a network (e.g. the Internet or World Wide Web). Various embodiments of the invention may also be implemented as hardware, firmware or any combination of software (e.g., a computer program product), hardware and firmware. Moreover, the functionality as depicted may be located on a single physical computing entity, or may be divided between multiple computing entities.

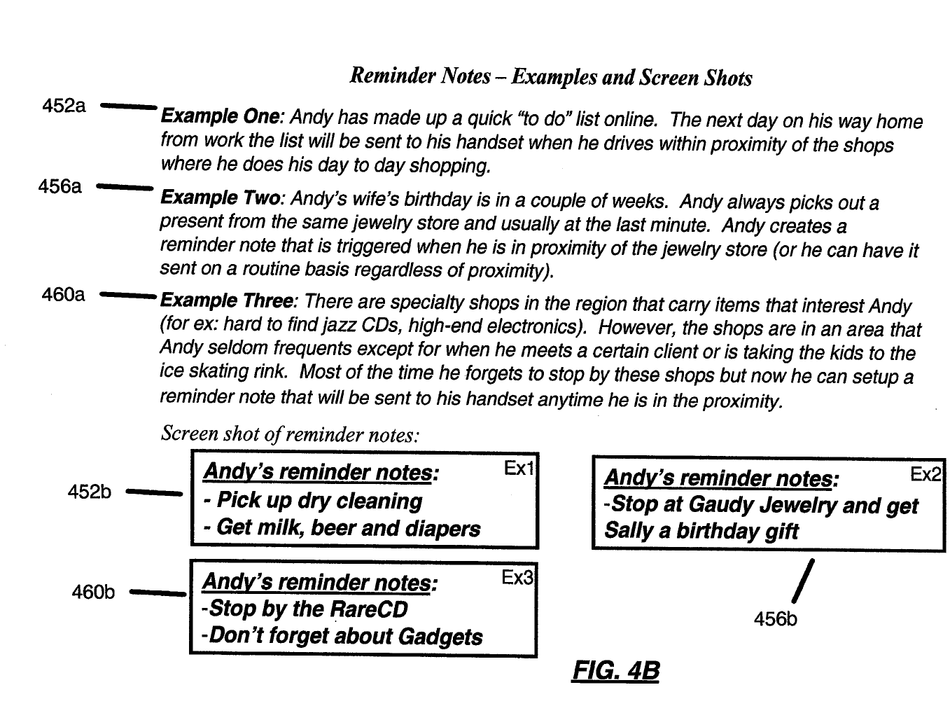

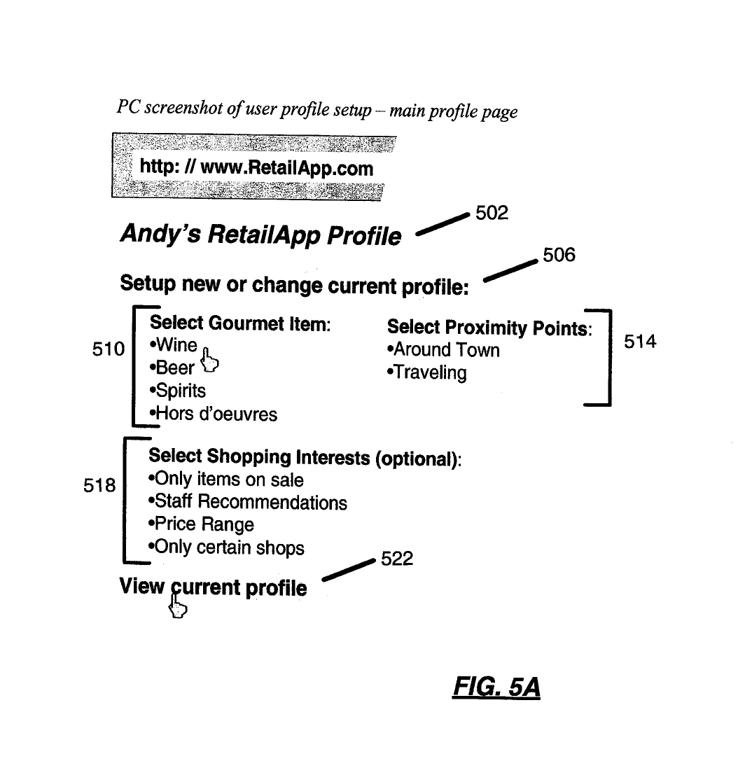

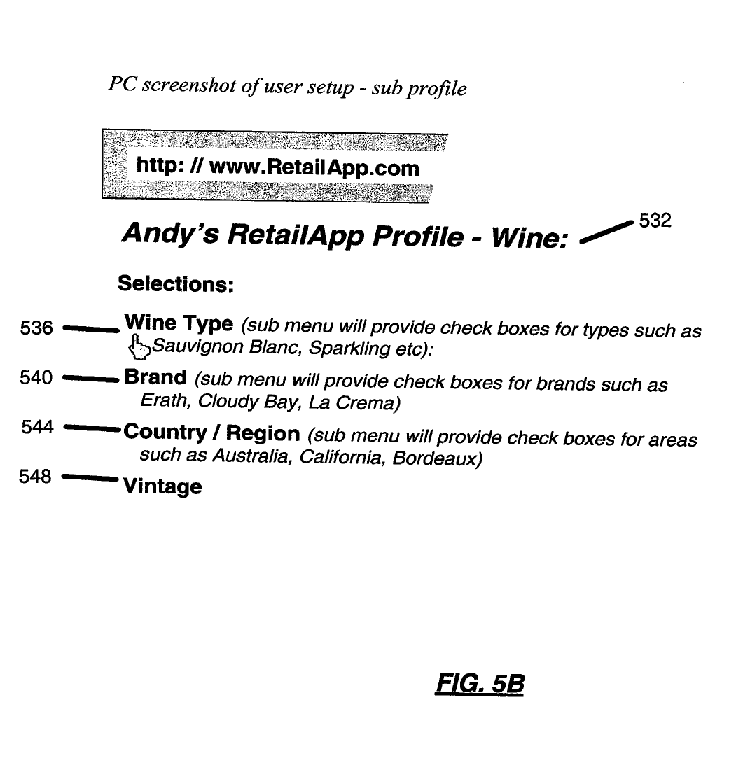

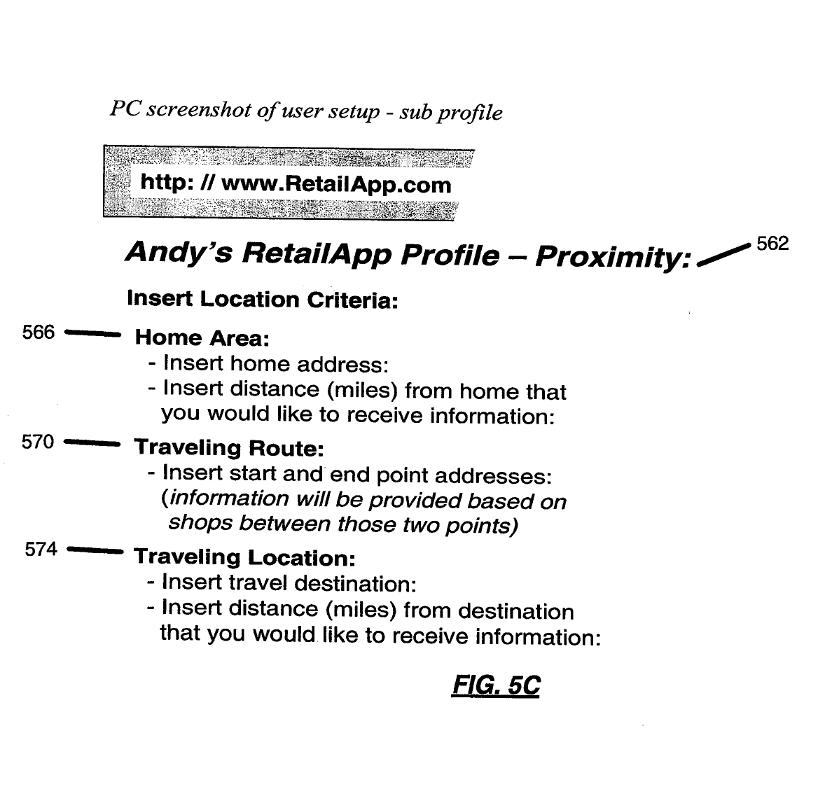

FIG. 4A illustrates a flow diagram suitable for demonstrating one or more aspects of the invention as described herein. Element 402 depicts a customer's computer (e.g., computer 300) activating a profile. More specifically, element 402 demonstrates that a customer may create and/or enter/populate a sales profile (described herein in accordance with FIGS. 5A-C). The sales profile may include information or data related to the customer's preferences. For example, a customer may enter information that indicates that he is interested in beverages, such as wine. The customer may explicitly indicate his interest in wine, or alternatively, the customer's computer (or database 408) may infer that the customer is interested in wine based on other entered data (e.g., an expressed interest in foods that typically go with wine, such as cheese and crackers). As in the case of wine, the subject matter of interest may be expressed in a general manner. Alternatively, or additionally, the subject matter may be expressed in a more specific manner. For example, the customer profile may indicate that the customer/user is primarily interested in red wine (as opposed to white wine), and that the customer's favorite type of wine is merlot. A customer profile may be configured such that it can be revised after its initial creation; this is particularly advantageous since customer preferences may change over time.

Customer profiles (e.g., the profile generation demonstrated via element 402) may be protected via an authorization or authentication scheme. For example, to ensure integrity and security of data, a customer may be required to enter a username and password, a personal identification number (PIN), or other identifying information to confirm that the customer is who he claims to be. A customer may have one profile for all of the various goods and services he may be interested in. For example, Andy, a potential customer, may have a profile/account setup under his username “andyisbest,” wherein Andy specifies that he has an interest in shark hunting, and an interest in wine only if a vineyard that produces the particular bottle is willing to offer a free tour of the premises. Alternatively, or additionally, profiles may be setup for each good and/or service. Thus, Andy may have a first usemame “andysharkhunter” under which all of Andy's preferences with respect to shark hunting vacations are located, and Andy may have a second username “andywines” under which all of Andy's preferences with respect to wine and vineyard services are located. Accordingly, it is understood that while FIG. 4A only shows one generation element 402, in practice there may be multiple customers generating profiles and/or each customer may generate multiple profiles. The profiles may be generated from a single source computer. Alternatively, the multiple profiles may be generated via a plurality of computers.

Database 408 may be used to store the one or more customer profiles that are generated via element 402. Database 408 may be implemented as any computing device/platform (e.g., computer 300). More specifically, database 408 may be implemented as a server and accompanying data storage. Access to database 408 may be restricted, wherein access may only be granted responsive to entry of a username and password, a PIN number, or the like. Moreover, access to database 408 may be restricted to a network administrator. In addition to element 402, database 408 may interact with other elements as discussed below.

Element 414 depicts a plurality of retailers/retailer computers (e.g., Retailer1, Retailer2, Retailer3) providing periodic sales information to database 408. As shown in FIG. 4A, the plurality of retailer computers may send the periodic sales information responsive to database 408 initiating/transmitting a query, wherein the query requests the retailer computers to provide updated sales information. In order to reduce the number of query requests that database 408 has to initiate and transmit, a query request may be sent to all retailer computers simultaneously. Alternatively, a query request may be configured to include identifying information such that each query request is targeted to a specific retailer computer. The retailer computers may each perform a matching or comparison function to determine whether it is the addressed retailer computer, and when it is, the addressed retailer computer may respond by transmitting updated sales information.

In at least one alternative embodiment, the retailer computers (Retailer1, Retailer2, Retailer3) may provide updated sales information without requiring database 408 to initiate a query request. For example, the retailer computers may be configured to send updates automatically on a weekly basis. The retailer computers may be configured to send their updated sales information at a common time (e.g., Sunday at 4:00 P.M.). Alternatively, the retailer computers may be configured to automatically send updated sales information in a staged manner, so as to not present an excessive load to database 408 at any particular instant in time. Thus, Retailer1 may be configured to send updated sales information on Sunday at 4:00 P.M., Retailer2 may be configured to send updated sales information on Monday at 10:00 A.M., and Retailer3 may be configured to send updated sales information on Tuesday at 8:00 A.M. The retailers/retailer computers may be required to partake in a registration process before gaining access to database 408.

Element 420 depicts a scenario wherein a Customer1, traveling with his mobile device, comes within a proximity or threshold distance of the location of a retailer (e.g., Retailer1). The customer's mobile device may be equipped with location tracking equipment to help facilitate this determination. For example, the customer's mobile device may be equipped with GPS tracking equipment. More specifically, the customer's mobile device may be configured to receive/download a software package that, once resident on the mobile device, transmits information (e.g., coordinates) of the mobile device outside of a network operator purview. Thereafter, a server/database (e.g., database 408) may send a message to the customer mobile device. The message may take the form of a Multimedia Message Service (MMS) message, a Short Message Service (SMS) message, or the like. Alternatively, or additionally, an application may be resident in the customer mobile device (e.g., as part of the mobile device fabrication, or downloaded and installed thereafter), and a network operator may perform a triangulation process or the like to determine the location of the customer mobile device.

The location of Customer1 may be compared with the location of the various retailers (e.g., Retailer1, Retailer2, Retailer3) to determine if Customer1 is within close proximity to participant retailers. When Customer1 is in close proximity to one or more participant retailers, Customer1's mobile device may be alerted (e.g., via an alert message in the form of an audible sound, and/or a message on the mobile device's display). Alternatively, or additionally, the one or more retailers' latest sales information may be forwarded to Customer1's mobile device from database 408 when in close proximity. As used herein, a reference to the location of the retailer and/or a retailer computer may refer to either of the location of the actual retailer's place of business (e.g., the retailer's store) or it may refer to the actual location of the retailer's computer in the event that the retailer's computer is not located in the retailer's place of business.

Hysteresis may be implemented to prevent repeatedly sending the same notification message (e.g., alert or sales information) to a customer who happens to be traveling along a path that largely coincides with the threshold distance (e.g., a circular path). The hysteresis may be based on a distance parameter and/or a time parameter, and may be fixed or variable.

The threshold distance for establishing whether a customer's mobile device is in close proximity to a given retailer may be setup on a global basis and assigned a default value (e.g., every customer who travels within five miles of a retailer is within the threshold distance). Alternatively, each customer may be able to stipulate what the appropriate threshold distance should be (e.g., Customer1 may stipulate that ten miles is an appropriate threshold distance). Furthermore, each customer may be able to stipulate what the appropriate threshold should be for each retailer (e.g., Customer1 may stipulate that ten miles is the appropriate threshold distance for Retailer1, and twenty miles is the appropriate threshold distance for Retailer2). A map, icons, and/or other graphical depictions may be displayed on the customer mobile device to assist a customer in entering a desired threshold distance. Alternatively, the customer's specification of distance might not be specific to the retailer, but rather, each type of good or service. For example, a customer may be indifferent as to the retailer of kitchen sponges, and may want to be notified when in close proximity to any retailer selling kitchen sponges. Alternatively, a customer may have a preference for shopping at a specific supermarket, and may want to be notified when in close proximity to that specific supermarket, potentially irrespective of whether the specific supermarket even sells kitchen sponges.

A customer may be reminded (via a reminder note or the like) when he is traveling that he needs to pick up a certain product, or acquire a certain service, within a specified time period. For example, when a customer gets into his car, he may be reminded that he needs to pick up bread and milk within the next three days, as the current supply at his house is running low. Thus, a customer may create a message, list or the like with a set of predefined parameters, and store the resultant message, list or the like online (e.g., on the Internet) such that a reminder message is sent to the customer's device (e.g., mobile device 200) when the customer enters or arrives at or within a proximate distance of a specific location. FIG. 4B illustrates additional scenarios 452a, 456a, and 460a, and accompanying reminder notes 452b, 456b, and 460b that may be sent to a customer device.

An optional step may be included so as to forward the sales information to Customer1's mobile device on a more selective basis (e.g., via a selective filtering algorithm). For example, when it is determined that Customer1 is in close proximity to the one or more retailers, a comparison may be performed to determine whether Customer1's profile indicates a preference for one or more products or services offered by each proximate retailer. As such, database 408 may be configured such that it only forwards sales information to Customer1's mobile device when a specific retailer's sales information “sufficiently matches” the preferences provided in Customer1's profile. What constitutes “sufficient matching” may be implemented on a system-wide basis, and may be set as a parameter such as “75% matching.” For example, in the context of wine purchases, Customer1 may express a preference for a wine having at least some of the following characteristics: (1) a merlot, (2) selling between $10/litre and $15/litre, (3) available for purchase at a vineyard within 30 miles of his current location (as identified by the current location of his mobile device in his possession), (4) with an overall customer rating of at least four out of five stars, and (5) made from grapes grown in California. Retailer1 may offer (1) a merlot, (2) selling at $12.50/litre, (3) located at a distance of 15 miles from Customer1's current location, (4) with an overall customer rating of five stars, but (5) made from grapes grown in Oregon. As such, since Retailer1 produces a wine that matches 80% (4 out of 5) of the characteristics Customer1 is interested in, the corresponding sales information may be forwarded to Customer1's mobile device from database 408. Conversely, the sales information of Retailer2 who only produces a wine matching 60% (e.g., 3 out of 5) of the characteristics might not be forwarded. In the alternative, rather than implementing a system-wide “sufficient matching” parameter (e.g., 75%), each customer profile may be configurable to enable a customer to specify the degree of matching required before sales information is forwarded. Furthermore, where multiple profiles and/or usernames are used, the test for sufficient-matching may take place based on a requirement to match parameters within multiple profiles (e.g., 85% matching on a first profile, and 55% on a second profile).

The sales information may undergo another form of selective filtering by providing Customer1's mobile device with “best-fit” sales information. For example, proximate retailers Retailer1, Retailer2, and Retailer3 may all produce a wine that “sufficiently matches” the preferences established by Customer1. Rather than sending the sales information attributed to Retailer1, Retailer2, and Retailer3 to Customer1, only the “best-fit” (e.g., the highest rated “sufficiently matching” percentage score) sales information may be forwarded to Customer1's mobile device, thereby alleviating Customer1 from having to perform a manual/visual comparison of the sales information attributed to the various matching retailers. Moreover, the referenced selective filtering may take into consideration customer preferences with respect to whether one of the retailers is a preferred retailer. This preference may be explicitly denoted in a customer profile, or the preference may be inferred based on sales information a customer has taken an interest in.

Element 426 of FIG. 4A depicts a scenario wherein a Customer2 uses his mobile device, or more specifically, a menu on his mobile device, to initiate a transfer of sales information from database 408 to his mobile device. As such, as depicted in element 426, a customer/user may manually request that sales information be forwarded to him. For example, with respect to wine sales, Customer2 may be indifferent to the fact that he is not within a threshold distance from a winery. Customer2 may be traveling from Arlington, Va. to Southampton, N.Y., and may want to know where the closest vineyard selling a bottle of merlot is in Southampton upon his arrival. To facilitate this practice, Customer2 may enter the name of his destination (“Southampton, N.Y.” ), the destination's postal zip code (“11968” ), or the like.

A customer may have further control over the forwarding of sales information/data to his mobile device. A customer may be able to opt-out of one or more services by pressing a button on his mobile device. For example, the customer may be able to filter out sales information received from a specific retailer after having viewed an advertisement from the retailer and deciding that he was not interested in the products or services offered by that retailer. The nature of the opt-out might be a message sent to a server/database (e.g., database 408) from the mobile device to prohibit the server/database from sending sales data/information to the mobile device. Alternatively, or additionally, the opt-out function may be located at the mobile device, wherein the mobile device may disregard or discard of sales data/information from specified retailers. Other filter controls may be implemented on a more global basis. For example, the customer may be able to specify that he does not want to receive more than ten advertisements per day. The opt-out/filter features may also be entered at a PC, workstation, or the like, and may be incorporated into a customer/user profile. Other blocking and/or filtering algorithms are well within the scope and spirit of the present invention.

The one or more retailers may further impose additional filtering constraints on the sales information/advertisements as well. For example, a sporting goods retailer looking to sell out stock of remaining winter ski equipment to make room for spring time sales of baseball bats and gloves may condition a discount on ski equipment to only be valid for a certain time period (e.g., one week). The discount may take place in accordance with online coupons, promotional codes, and the like, and may be integrated with existing retailer tools. The discounts may be offered as part of a larger registration system/scheme.

Security constraints may be imposed on the mobile device to ensure security/privacy. These constraints may include a requirement that a customer/user enter a username and password, a PIN number, or the like in order to gain access to the mobile device. Alternatively, or additionally, a feature may be present to enable the mobile terminal to “remember” the customer, or more specifically his login information, so as to not require the customer to enter his login information every time.

Directions may be provided to a customer's mobile device to provide an indication as to how to best get to a selected retailer's location. The directions may be included with the transfer of the sales information to the mobile device. Alternatively, or additionally, a customer may have to take an action, such as pushing one or more buttons on the mobile device, to initiate the transfer of the directions.

FIG. 5A illustrates an exemplary screen shot of a customer/user profile setup—main profile page suitable for demonstrating one or more aspects of the invention described herein. More specifically, a customer/user profile 502 (Andy's SiftWalk Gourmet Profile) is provided. A customer/user (named Andy) is provided an opportunity to setup a new profile or change a current customer/user profile via menu 506. Andy can choose items from enumerated listings. For example, with respect to the noted profile 502, Andy can choose from a listing of gourmet items 510 (e.g., wine, beer, spirits, or hors d'oeuvres). Andy can also choose the nature of his intended travels to which the profile applies via traveling menu 514. For example, Andy can choose whether the profile is to apply/be triggered responsive to traveling around town, or whether it is to apply on a more global basis. Andy may establish his interest levels via menu 518. For example, Andy may condition his profile (and hence, the sales information/advertisements that he receives) based on on-sale status of items, staff recommendations, price ranges, and retailer names (e.g., certain shops). A menu/button 522 may also be provided to allow Andy to view the current selections in his current gourmet profile 502.

FIG. 5B illustrates a sub-profile suitable for demonstrating one or more aspects of the invention described herein. More specifically, sub-profile “wine” 532 may be generated responsive to Andy selecting “wine” from the listing of gourmet items 510 of FIG. 5A. As shown in FIG. 5B, Andy may be provided with an opportunity to select/condition his choice of wine based on a variety of categories. For example, Andy may be able to pick a wine type 536, a brand 540, a country/region of origin 544, or a vintage 548. Other classifications/categories are possible. Check boxes, buttons, sub-menus, and the like may be provided (not shown) to facilitate further selection.

FIG. 5C illustrates a sub-profile suitable for demonstrating one or more aspects of the invention described herein. More specifically, sub-profile “proximity” 562 may be generated responsive to Andy selecting traveling menu 514 of FIG. 5A. Andy may be provided an opportunity to insert location criteria related to his home area 566, his intended traveling route 570, and/or his traveling location 574. Selecting home area 566 may provide Andy an opportunity to enter information related to his home address and the distance (e.g., in miles) from home that he would like to receive information. Selecting traveling route 570 may provide Andy an opportunity to enter a start point address and an end point address, and information may be provided. based on shops/stores/retailers located between those two points. Selecting traveling location 574 may provide Andy an opportunity to enter a travel destination, and Andy may further indicate how far (in terms of miles, for example) from the identified travel destination Andy would be willing to go to obtain a product or service. Additional location criteria (not shown) may be provided.

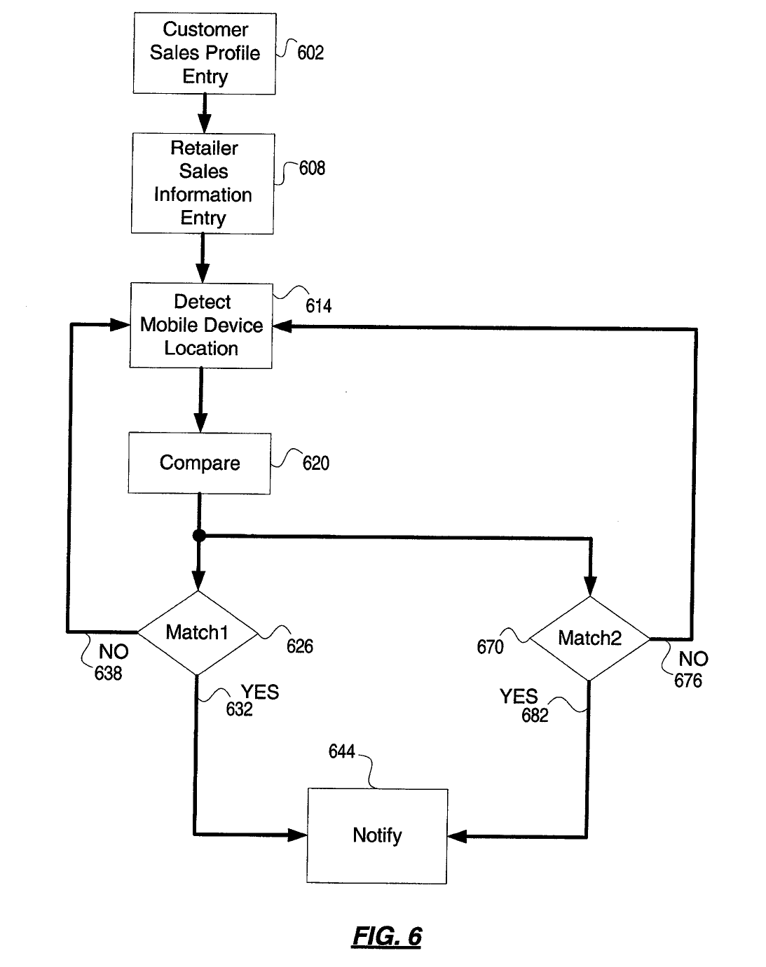

FIG. 6 illustrates a flow chart suitable for demonstrating one or more aspects of the invention described herein. In step 602, a customer may enter his sales profile information (e.g., in accordance with the preceding description of element 402 of FIG. 4A). In step 608, one or more retailers may enter (periodic) sales information (e.g., in accordance with the preceding description of element 414 of FIG. 4A). In step 614, a customer's mobile device may detect its current location. Alternatively, one or more computing devices in a network environment may detect the location of the customer's mobile device. In step 620, a comparison may be performed based on one or more criteria; the one or more criteria may include: (1) the customer's detected location (e.g., the location detected in step 614), (2) the location of one or more retailers, (3) the sales information entered by the one or more retailers (e.g., the sales information entered in step 608), and (4) the information entered into the customer profile (e.g., the information entered by the customer in step 602).

The operation associated with the flow chart of FIG. 6 may deviate based on whether the customer's mobile device is operating in an automated/push mode (e.g., Customer1, element 420 of FIG. 4A) or in a manual/pull mode (e.g., Customer2, element 426 of FIG. 4A). For example, match1 (626) may correspond to the automated mode of operation. In the automated mode of operation, match1 (626) may ensure that the customer's detected location (614) is within a threshold distance of one or more retailers, and that the customer's profile (602) sufficiently matches the sales information entered by the corresponding one or more retailers (608). If there is a match (“YES”, 632), then the customer's mobile device may be notified of the matching retailer(s)' sales information (644). Conversely, if there is no match (“NO”, 638), then the flow chart may resume at step 614 in order to continue detecting the mobile device's location.

In the manual mode of operation, match2 (670) may effectively be responding to a customer request for information. As such, if the foregoing criteria is met with respect to the customer's location (614) and/or his customer profile (602), a match may be confirmed (“YES”, 682) and a notification may be sent to customer's mobile device with the corresponding, matching sales information.

Match2 (670) may attempt to balance the comparison performed between the customer's distance (614) from the one or more retailers and how close the customer's profile (602) matches with the retailer sales information (608) when an immediate match is not available. For example, if a customer requests information on wine-retailers, and the customer is detected (614) to be in Arlington, Va., it might not be practical to send the customer sales information originating from wine-retailers in Long Island, N.Y., even though the Long Island wines may come the closest to meeting the customer's wine preferences. Conversely, it might not make sense to send the customer sales information from wine-retailers in Arlington if the customer doesn't care for wine produced and sold in Arlington. As such, match2 (670) may also entail sending one or more inquiries/requests to the customer, requesting the customer to provide information related to how far the customer is willing to travel and/or how far the customer is willing to deviate from the preferences he established in his sales profile (e.g., 602). Responsive to the customer's answers to the one or more inquiries/requests, if a match is not generated (“NO”, 676), a message may be generated on the customer's mobile device to this effect. Otherwise, a match may be confirmed (“YES”, 682) and a notification and/or sales information may be sent to the customer's mobile device (644).

Matching (e.g., match1 626 and/or match2 670) may be facilitated based on previous decisions or selections made. For example, future matching operations with respect to winter ski equipment may be influenced by a customer expressing an interest in snow boots. Furthermore, if a customer demonstrated a willingness to spend between $50 and $70 on a new pair of snow boots, heuristics may be used to infer that the customer would be willing to spend between $225 and $285 on a new pair of ski poles. Other scenarios are well within the scope and spirit of the present invention.

When a match (e.g., match1 626 and/or match2 670) is established, one or more products or services may be purchased via a pre-pay scheme. Thereafter, a retailer may set aside or allocate an equivalent quantity or quality of merchandise to be picked up by the customer (or to be shipped to the customer) on a future date. The pre-payment may take place using a credit card, a debit card, or other such payment mechanisms.

Variations of the flow chart as depicted in FIG. 6 are well within the scope and spirit of the invention. For example, it is understood that a customer may edit or modify the information he has entered in his profile in step 602. Similarly, one or more retailers may edit or modify the sales information entered in step 608. As such, those respective steps may be re-entered at any particular point.

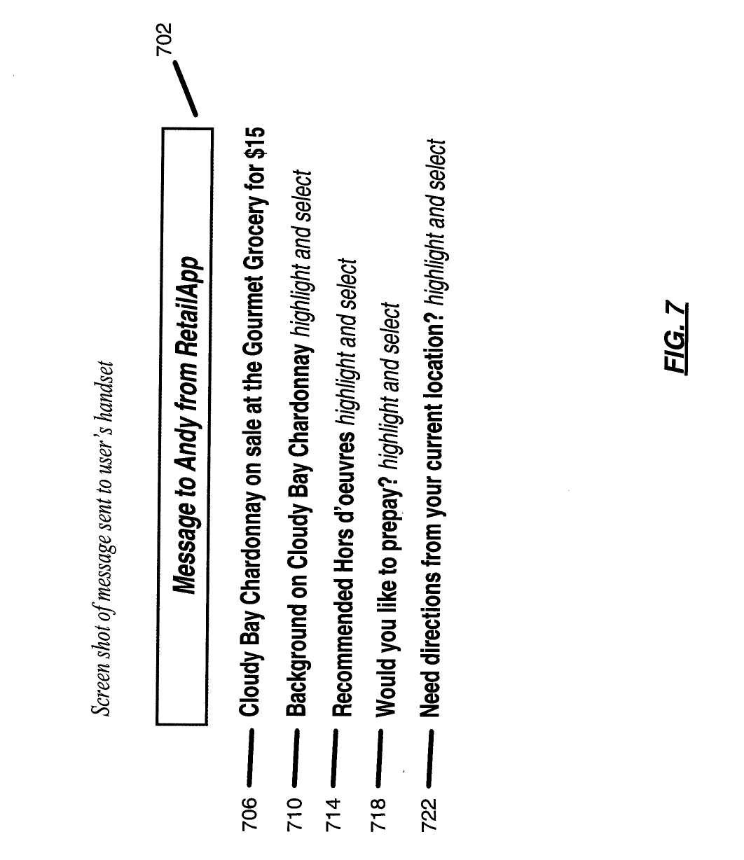

FIG. 7 illustrates an exemplary screen shot that may be received at a computing device (e.g., mobile device 200) responsive to a match (e.g., match1 626 and/or match2 670) having been identified. More specifically, FIG. 7 shows a message 702 sent to Andy related to wine. Message 702 may be implemented using standard messaging service protocols, such as the Multimedia Message Service (MMS), the Short Message Service (SMS), or the like. Accordingly, it may be possible to provide message 702 without requiring any changes to a conventional computing device (e.g., mobile device 200).

Message 702 is shown as taking the form of an advertisement; sub-message 706 may indicate that a local retailer (e.g., the Gourmet Grocery) has placed Cloudy Bay Chardonnay on sale for $15. Message 702 may also provide Andy an opportunity to review additional information on the advertised wine. For example, message 702 may provide a sub-menu 710 that would enable Andy to review background information related to Cloudy Bay Chardonnay upon selection. Sub-menu 714 may provide Andy with information related to recommended hors d'oeuvres upon selection. Sub-menu 718 may provide Andy the ability to prepay for a quantity of the advertised Cloudy Bay Chardonnay. The prepayment may take place in accordance with a general credit card, debit card, or the like, enabling Andy to pay for Cloudy Bay Chardonnay along with other general purchases (e.g., car services at the local repair shop, movie tickets, etc.) Alternatively, an individualized account may be established for each product or service, at any level of abstraction or specificity (e.g., an account may be setup for beverages in general, or an account may be setup for Cloudy Bay Chardonnay specifically). Sub-menu 722 may generate travel directions from Andy's current location to the Gourmet Grocery upon selection. Additional sub-menus (not shown) may be implemented. The sub-menus (e.g., sub-menus 710-722) may be implemented as links to web pages or the like to facilitate information retrieval and/or data entry.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method comprising:
receiving a customer profile with customer data;
receiving sales data from a retailer;
determining a location of a customer mobile device;
determining that the location of the customer mobile device is within a threshold distance of the retailer;
determining that the customer data sufficiently matches the sales data; and
responsive to determining that the specified location of the customer mobile device is within a threshold distance of the retailer, and determining that the customer data sufficiently matches the sales data, sending a notification message to the customer mobile device.

2. The computer implemented method of claim 1, wherein the step of determining a location of the customer mobile device is based on a current location of the customer mobile device.

3. The computer implemented method of claim 1, wherein the step of determining that the customer data sufficiently matches the sales data includes a determination that the customer data explicitly matches the sales data.

4. The computer implemented method of claim 1, wherein the step of determining that the customer data sufficiently matches the sales data includes an inference that the customer data matches the sales data.

5. The computer implemented method of claim 1, further comprising a step of authenticating a customer prior to receiving the customer profile with customer data.

6. The computer implemented method of claim 1, wherein the step of receiving sales data from a retailer is responsive to a query request for the sales data.

7. The computer implemented method of claim 1, wherein the step of receiving sales data from a retailer is configured to occur on a periodic basis.

8. The computer implemented method of claim 1, wherein the step of sending a notification message to the customer mobile device includes sending the customer mobile device an alert message, wherein the alert message includes either an audible sound or a message to be displayed on a display device.

9. The computer implemented method of claim 1, wherein the step of sending a notification message to the customer mobile device includes sending the sales data to the customer mobile device.

10. The computer implemented method of claim 1, wherein the step of sending a notification message to the customer mobile device is based on hysteresis to prevent a notification message from repeatedly being sent to the customer mobile device when the customer mobile device is traveling along a path that is approximately equal to the threshold distance.

11. The computer implemented method of claim 1, wherein the notification message includes at least one of a Multimedia Message Service (MMS) message or a Short Message Service (SMS) message.

12. The computer implemented method of claim 1, wherein the notification message includes a reminder note that a corresponding customer needs to acquire a product or service within a specified time period.

13. The computer implemented method of claim 1, wherein the step of sending a notification message to the customer mobile device is further based on at least one additional customer profile sufficiently matching the sales data.

14. The computer implemented method of claim 1, wherein the step of determining that the customer data sufficiently matches the sales data is based on a customer preference for a specific retailer.

15. The computer implemented method of claim 1, further comprising:
receiving from the customer mobile device a pre-payment request, and
allocating a corresponding quantity of merchandise identified by the sales data for a corresponding customer.

16. The computer implemented method of claim 9, wherein the sales data includes a promotional discount on at least one good or service, and wherein the promotional discount is valid for a specified time, and wherein the promotional discount is configured to be applied to a sale once accepted at the customer mobile device.

17. An apparatus comprising:
a processor; and
a memory configured to store computer readable instructions that, when executed by the processor, cause the apparatus to:
receive customer data from a customer computing device;
receive sales data from a retailer computer;
determine that a customer mobile device is located within a threshold distance of a location of a retailer corresponding to the retailer computer;
determine that the customer data sufficiently matches the sales data; and
send a notification message to the customer mobile device responsive to determining that the customer data sufficiently matches the sales data.

18. The apparatus of claim 17, wherein the computer readable instructions further include an instruction to transmit a query request for the sales data to the retailer computer.

19. The apparatus of claim 17, wherein the notification message includes the sales data.

20. The apparatus of claim 17, wherein the customer data includes a sufficiently matching parameter, and wherein the sufficiently matching parameter is used by the instruction that determines that the customer data sufficiently matches the sales data.

21. A method comprising:
receiving customer data from a customer computing device;
receiving sales data from a plurality of retailer computers;
determining that a customer mobile device is located within a threshold distance of a location of a retailer corresponding to at least one of the retailer computers;
determining that the customer data sufficiently matches the sales data corresponding to the at least one of the retailer computers; and
sending a notification message to the customer mobile device responsive to determining that the customer mobile device is located within a threshold distance of a location of a retailer corresponding to at least one of the retailer computers and determining that the customer data sufficiently matches the sales data corresponding to the at least one of the retailer computers.

22. The method of claim 21, wherein the method further includes a step of transmitting a query request for the sales data to the plurality of retailer computers.

23. The method of claim 22, wherein the query request includes identifying information to identify a particular one of the plurality of retailer computers.

24. The method of claim 21, wherein the sales data is received from the plurality of retailer computers in a staged manner.

25. The method of claim 21, wherein the method further includes a step of receiving an opt-out message from the customer mobile device.

26. The method of claim 21, wherein the notification message includes best-fit sales data when the current location of the customer mobile device is within a threshold distance of at least two of the plurality of retailer computers and when the customer data sufficiently matches the sales data corresponding to each of the at least two of the plurality of retailer computers.

27. The method of claim 1, wherein the sending of the notification message to the customer mobile device is further responsive to the creation of a customer message that serves as a reminder to acquire a product or service.
